(19) United States
(12) Patent Application Publication
(10) Pub. No.: US 2020/0070871 A1
(43) Pub. Date: Mar. 5, 2020

(54) VEHICLE STEERING WHEEL ASSEMBLY AND VEHICLE

(71) Applicant: CITIC Dicastal CO., LTD., Qinhuangdao (CN)

(72) Inventors: Dexi DU, Qinhuangdao (CN); Dadong WANG, Qinhuangdao (CN); Weidong LIU, Qinhuangdao (CN); Shaoqian WANG, Qinhuangdao (CN); Shiwen XU, Qinhuangdao (CN); Zhihua ZHU, Qinhuangdao (CN)

(21) Appl. No.: 16/390,107

(22) Filed: Apr. 22, 2019

(30) Foreign Application Priority Data
Sep. 5, 2018 (CN) 201811032330.3

(51) Int. Cl. B62D 5/00; B62D 15/02; B62D 5/04

(52) U.S. Cl. CPC B62D 5/006; B62D 5/0409; B62D 5/0481; B62D 15/022

(57) ABSTRACT

A vehicle steering wheel assembly includes a steering wheel, a control component, a rotation measuring component for measuring the rotation condition of the steering wheel, and a road sense simulator for applying a resistance torque to the rotation of the steering wheel according to the rotation condition of the steering wheel; a steering column is disposed under the steering wheel, in which the upper end of the steering column is connected to the steering wheel, and the lower end of the steering column is connected to the road sense simulator, and the road sense simulator is fixed to the vehicle body of the vehicle. The rotation measuring component and the road sense simulator are both connected to the control component, and the control component controls the road sense simulator to apply the resistance torque to the rotation of the steering wheel according to measurement data of the rotation measuring component.

### CROSS-REFERENCE TO RELATED APPLICATIONS

The present application claims benefit of Chinese Application No. 201811032330.3, filed on Sep. 5, 2018, the contents of which are hereby incorporated by reference in its entirety.

### BACKGROUND

In the centuries since the birth of the vehicle, the types of the vehicle steering systems generally include: mechanical steering system, Hydraulic Power Steering System (HPS), Electronic Hydrostatic Power Steering System (EHPS), Electric Power Steering System (EPS) and Steer By Wire System (SBW). Among them, the Steer By Wire System eliminates the mechanical connection between the steering wheel and the turning wheels of the vehicle. Instead, the digital signal transmission is used directly to establish the communication between the steering control component and the steering execution component, and the driving intention can be quickly judged to realize the rapid and flexible steering of the vehicle; at the same time, it has the advantages of small occupied space and reduced damage to the driver when the vehicle collides, which is very suitable for the intelligent requirements of the vehicle. Therefore, the Steer By Wire System has become a research hotspot and future development trend of current vehicle steering systems.

However, in the existing vehicle steering system, the steering wheel assembly has problems such as complicated structure, large space occupation and the like, and cannot meet the intelligent requirements of the vehicle.

### SUMMARY

The disclosure relates to a vehicle steering system technology, in particular to a vehicle steering wheel assembly and a vehicle.

In view of this, an object of the present disclosure is to provide a vehicle steering wheel assembly and a vehicle having a simple structure and occupying a small space.

In order to achieve the above object, the technical solution of the present disclosure is achieved as follows:

A vehicle steering wheel assembly, includes a steering wheel, a control component, a rotation measuring component for measuring the rotation condition of the steering wheel, and a road sense simulator for applying a resistance torque to the rotation of the steering wheel according to the rotation condition of the steering wheel; a steering column is disposed under the steering wheel, the upper end of the steering column is connected to the steering wheel, and the lower end of the steering column is connected to the road sense simulator, and the road sense simulator is fixed to the vehicle body of the vehicle;

the rotation measuring component and the road sense simulator are both connected to the control component, and the control component controls the road sense simulator to apply the resistance torque to the rotation of the steering wheel according to the measurement data of the rotation measuring component.

The vehicle steering wheel assembly, the road sense simulator includes a motor, in which the lower end of the steering column is connected to the output shaft of the motor, and the steering column and the output shaft rotate coaxially; and the housing of the motor is fixed to the vehicle body of the vehicle, and the output torque of the motor is the resistance torque applied to the rotation of the steering wheel by the road sense simulator.

The vehicle steering wheel assembly, the rotation measuring member is an encoder, and the encoder includes a fixing portion and a measuring portion, in which the fixing portion is fixed to the upper end of the housing of the motor, and the measuring portion is sleeved on the output shaft.

the road sense simulator further includes a motor controller, in which the motor controller is fixed to the housing of the motor, and the motor controller receives a control signal of the control component and controls the output torque of the motor according to the control signal.

the vehicle steering wheel assembly further includes a steering wheel rotation limiting device, in which the steering wheel rotation limiting device includes a first limiting member and a second limiting member; the first limiting member is slidably mounted on the steering column, and the first limiting member is movable along the axial direction of the steering column with the rotation of the steering wheel; the second limiting member is disposed on the steering column, and the upper end and the lower end of the second limiting member are respectively provided with a stopping portion, and the stopping portions are respectively positioned above and below the first limiting member, in which, after the steering wheel is rotated by a predetermined angle, the first limiting member abuts against the stopping portion of the upper end or the lower end of the second limiting member, and the rotation of the steering wheel is restricted.

The vehicle steering wheel assembly, the first limiting member is a limiting block movable along the axial direction of the steering column, and the second limiting member is a spiral groove with a preset number of circles which is provided on the outer cylindrical surface of the steering column and sets the axis of the steering column as its axis, in which one end of the limiting block is slidable in the spiral groove, and the start portion and the end portion of the spiral groove are the two stopping portions of the second limiting member; and the steering wheel rotation limiting device further includes a limiting sleeve, in which the limiting sleeve is fixed on the vehicle body of the vehicle and is sleeved on the steering column, and the inner wall of the limiting sleeve is provided with a sliding groove for accommodating the axial movement of the other end of the limiting block.

the vehicle includes a vehicle body and the vehicle steering wheel assembly; the steering column is rotatably mounted to the vehicle body, and the road sense simulator is fixed to the vehicle body; and the control component is an electronic control unit.

the road sense simulator includes a motor, the lower end of the steering column is connected to the output shaft of the motor, and the steering column and the output shaft rotate coaxially; and the housing of the motor is fixed to the vehicle body, and the output torque of the motor is the resistance torque applied to the rotation of the steering wheel by the road sense simulator.

the rotation measuring member is an encoder, the encoder includes a fixing portion and a measuring portion, the fixing portion is fixed to the upper end of the housing of the motor, and the measuring portion is sleeved on the output shaft.

the steering wheel assembly further includes a steering wheel rotation limiting device, the steering wheel rotation limiting device includes a first limiting member and a second limiting member; the first limiting member is slidably mounted on the steering column, and the first limiting member is movable along the axial direction of the steering column with the rotation of the steering wheel; the second limiting member is disposed on the steering column, and the upper end and the lower end of the second limiting member are respectively provided with a stopping portion, and the stopping portions are respectively positioned above and below the first limiting member, in which, after the steering wheel is rotated by a predetermined angle, the first limiting member abuts against the stopping portion of the upper end or the lower end of the second limiting member, and the rotation of the steering wheel is restricted.

For the vehicle steering wheel assembly and the vehicle of the present disclosure, the vehicle steering wheel assembly includes a steering wheel, a control component, a rotation measuring component for measuring the rotation condition of the steering wheel, and a road sense simulator for applying a resistance torque to the rotation of the steering wheel according to the rotation condition of the steering wheel; a steering column is disposed under the steering wheel, in which the upper end of the steering column is connected to the steering wheel, and the lower end of the steering column is connected to the road sense simulator, and the road sense simulator is fixed to the vehicle body of the vehicle; it can be seen that the vehicle steering wheel assembly and the vehicle of the disclosure eliminate the mechanical connection structure between the steering mechanisms of the wheels, and the steering control member collects the rotation conditions of the steering wheel to directly control the steering mechanisms of the wheels, so that the steering wheel assembly has simpler structure and occupies less space.

### BRIEF DESCRIPTION OF THE DRAWINGS

FIG. 1 is a schematic view of the vehicle steering wheel assembly according to Embodiment 1 of the present disclosure;

FIG. 2 is a cross-sectional view showing the steering wheel rotation limiting device in the vehicle steering wheel assembly according to Embodiment 1 of the present disclosure; and

FIG. 3 is a schematic view of the vehicle according to Embodiment 2 of the present disclosure.

### LIST OF REFERENCE SYMBOLS

1 steering wheel
2 rotation measuring component
3 road sense simulator
31 motor
32 motor controller
4 control component
5 steering column
6 vehicle body
7 steering wheel rotation limiting device
71 first limiting member
72 second limiting member
721, 722 stopping portion
73 limiting sleeve
731 sliding groove

### DETAILED DESCRIPTION

An embodiment of the present disclosure provides a vehicle steering wheel assembly which includes a steering wheel, a control component, a rotation measuring component for measuring the rotation condition of the steering wheel, and a road sense simulator for applying a resistance torque to the rotation of the steering wheel according to the rotation condition of the steering wheel; a steering column is disposed under the steering wheel, in which the upper end of the steering column is connected to the steering wheel, and the lower end of the steering column is connected to the road sense simulator, and the road sense simulator is fixed to the vehicle body of the vehicle; the rotation measuring component and the road sense simulator are both connected to the control component, and the control component controls the road sense simulator to apply the resistance torque to the rotation of the steering wheel according to the measurement data of the rotation measuring component.

The vehicle steering wheel assembly of the embodiment of the disclosure eliminates the mechanical connection structure between the steering mechanisms of the wheels, and the steering control member collects the rotation conditions of the steering wheel to directly control the steering mechanisms of the wheels, so that the steering wheel assembly has simpler structure and occupies less space.

The detailed technical solution of the present disclosure will be described in detail with reference to the accompanying drawings and specific embodiments. It should be understood that the accompanying drawings and examples are only used to explain the present disclosure and are not used to define the present disclosure. In order to clearly describe the detailed technical solutions of the embodiments of the present disclosure, the upper and lower directions described below are the directions in which the vehicle steering wheel assembly of the embodiment of the present disclosure has been mounted on the vehicle.

### Embodiment 1

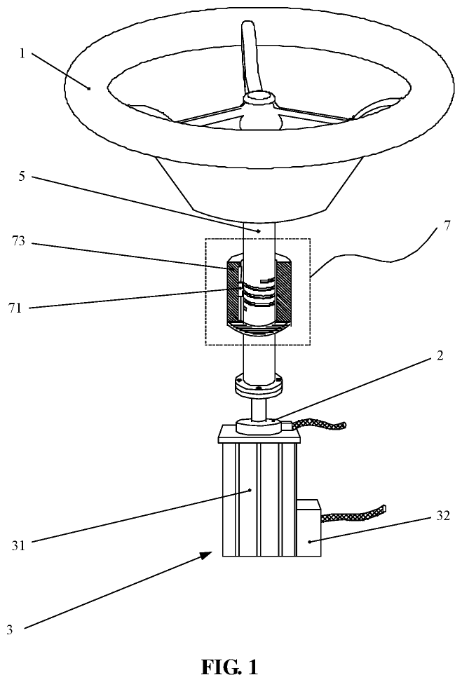

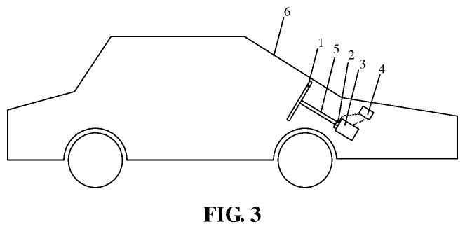

As shown in FIG. 1 and FIG. 3, an embodiment of the present disclosure provides a vehicle steering wheel assembly which includes a steering wheel 1, a control component 4, a rotation measuring component 2 for measuring the rotation condition of the steering wheel 1, and a road sense simulator 3 for applying a resistance torque to the rotation of the steering wheel 1 according to the rotation condition of the steering wheel 1. A steering column 5 is disposed under the steering wheel 1, in which the upper end of the steering column 5 is connected to the steering wheel 1, and the lower end of the steering column 5 is connected to the road sense simulator 3, and the road sense simulator 3 is fixed to the vehicle body 6 of the vehicle.

The rotation measuring component 2 and the road sense simulator 3 are both connected to the control component 4, and the control component 4 controls the road sense simulator 3 to apply the resistance torque to the rotation of the steering wheel 1 according to the measurement data of the rotation measuring component 2.

Here, the measurement data includes the data such as steering, corner, rotation speed and the like.

Specifically, the steering wheel 1 rotates to drive the steering column 5 connected below to rotate, and the rotation measuring component 2 obtains the rotation condition of the steering wheel 1 by measuring the data such as the steering direction, the rotation angle, the rotation speed and the like of the steering column 5, and transmits the rotation condition to the control component 4. The control component 4 sends a steering command to the steering mechanisms of the wheels to perform steering according to the received rotation condition of the steering wheel 1. The vehicle steering system feeds back the actual road sense at the time of steering, such as wheel rotation resistance, to the control component 4. The control component 4 transmits a control signal to the road sense simulator 3 according to the feedback road sense information, and the road sense simulator 3 applies a resistance torque to the rotation of the steering wheel 1 according to the received control signal, so that the vehicle steering wheel assembly of the embodiment of the present disclosure still has a good and real road sense under the situation without mechanical connections.

Further, in addition to adjust the resistance torque applied to the rotation of the steering wheel 1 by the road sense simulator 3 according to the wheel rotation resistance, the control component 4 can also adjust the resistance torque applied to the rotation of the steering wheel 1 by the road sense simulator 3 according to the speed of the vehicle traveling, that is, the vehicle speed. The steering resistance is generally large when the vehicle speed is slow, and vice versa, the steering resistance is smaller, which is more in line with the user's previous driving experience. In addition, since it is an unsafe driving behavior of too large steering angle when the vehicle speed is high, the control component 4 can accordingly correct the steering angle according to the situation, that is, if the steering angle is too large when the vehicle speed is high, the control component 4 can reduce the steering angle to a safe range. It can be understood that, in addition to the wheel rotation resistance, there are many factors affecting the resistance torque applied to the rotation of the steering wheel 1 by the road sense simulator 3, such as the vehicle speed, the steering acceleration, etc. More information of the vehicle is collected, and it is more accurate to adjust the resistance torque applied to the rotation of the steering wheel 1 by the road sense simulator 3. It is also possible to collect only the rotational resistance of the wheel.

Further, because the road surface condition is similar and the rotational resistance of the wheel is also substantially similar in most cases, the control component 4 can directly control the road sensation simulator 3 to apply a resistance torque to the rotation of the steering wheel 1 according to the received rotation condition of the steering wheel 1, so that the structure can be simplified and the reaction speed of the road sense simulator 3 can be improved.

In the present embodiment, the road sense simulator 3 includes a motor 31 and a motor controller 32. The lower end of the steering column 5 is connected to the output shaft of the motor 31, and the steering column 5 and the output shaft rotate coaxially. The housing of the motor 31 is fixed to the vehicle body 6 of the vehicle, and the output torque of the motor 31 is the resistance torque applied to the rotation of the steering wheel 1 by the road sense simulator 3. The motor controller 32 is fixed to the housing of the motor 31, and the motor controller 32 receives the control signal of the control component 4 and controls the motor 31 to output torque according to the control signal. The resistance torque is outputted by the motor 31, so that the structure is simple, and the control is convenient; it can be understood that the road sense simulator 3 can also be composed of other devices, for example, a hydraulic rotary damper can be included. The motor can be an AC asynchronous motor equipped with an inverter, and more specifically can be a three-phase AC asynchronous motor, which has the advantages of simple structure, reliable operation, low price, strong overload capability, and convenient use, installation and maintenance; and the motor may be a DC brushless motor, but the present disclosure is not limited thereto.

In addition, in order to prevent the output shaft of the motor 31 from freely rotating, the free rotation of the output shaft of the motor 31 can be restricted through the holding torque of the motor 31 by keeping the motor 31 energized, or the free rotation of the output shaft of the motor 31 can also be restricted by providing a lock device inside the motor 31, but the present disclosure is not limited thereto.

Preferably, in order to enable the steering column 5 to rotate coaxially with the output shaft, the lower end of the steering column 5 is provided with a flange, and the upper end of the output shaft is also provided with a flange, in which the flange of the lower end of the steering column 5 is fixedly connected to the flange of the output shaft by screws. It can be understood that the coaxial rotation of the steering column 5 and the output shaft can also be achieved by other means, for example, the steering column 5 and the output shaft can also be integrally formed together, or the steering column 5 and the output shaft are connected by an universal joint.

In the present embodiment, the rotation measuring member 2 is an encoder, and the encoder includes a fixing portion and a measuring portion, in which the fixing portion is fixed to the upper end of the housing of the motor 31, and the measuring portion is sleeved on the output shaft. The encoder is a common detecting component for measuring angular displacement, and has the advantages of high detection precision, simple implementation, etc. It can be understood that the rotational measuring component 2 may also be other detecting components, such as a rotary potentiometer or the like.

Preferably, the embodiment further integrates the rotation measuring component 2 and the motor 31 to further simplify the structure and reduce the occupied space.

In the present embodiment, the encoder may be a photoelectric encoder. The encoder and the motor controller 32 can be connected to the control component 4 by wire or wirelessly, respectively. It can be understood that the encoder can also be other types of encoders, such as a magneto-electric encoder.

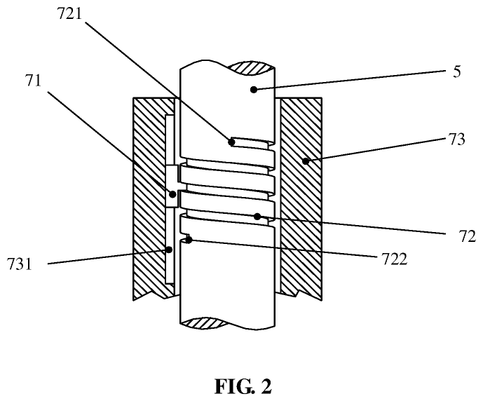

In the present embodiment, the vehicle steering wheel assembly may further include a steering wheel rotation limiting device 7. As shown in FIG. 1 and FIG. 2, the steering wheel rotation limiting device 7 includes a first limiting member 71 and a second limiting member 72. The first limiting member 71 is slidably mounted on the steering column 5, and the first limiting member 71 is movable along the axial direction of the steering column 5 with the rotation of the steering wheel 1. The second limiting member 72 is disposed on the steering column 5, and the upper end and the lower end of the second limiting member 72 are respectively provided with a stopping portion 721 and 722, and the stopping portions 721 and 722 are respectively positioned above and below the first limiting member 71. After the steering wheel 1 is rotated by a predetermined angle, the first limiting member 71 abuts against the stopping portion 721 of the upper end of the second limiting member 72 or the stopping portion 722 of the lower end thereof, and the rotation of the steering wheel 1 is restricted.

In the present embodiment, the first limiting member 71 is a limiting block movable along the axial direction of the steering column 5, and the second limiting member 72 is a spiral groove with a preset number of circles which is provided on the outer cylindrical surface of the steering column 5 and sets the axis of the steering column 5 as its axis, in which one end of the limiting block is slidable in the spiral groove, and the start portion and the end portion of the spiral groove are the two stopping portions 721 and 722 of the second limiting member 72. The steering wheel rotation limiting device 7 further includes a limiting sleeve 73, in which the limiting sleeve 73 is fixed on the vehicle body 6 of the vehicle and is sleeved on the steering column 5, and the inner wall of the limiting sleeve 73 is provided with a sliding groove 731 for accommodating the axial movement of the other end of the limiting block. Here, the spiral groove may be directly machined on the surface of the steering column, or an externally threaded sleeve may be additionally installed.

Specifically, when the vehicle is moving forward, both ends of the limiting block are respectively located in the middle position of the spiral groove and the sliding groove 731. When the vehicle turns to one side, the steering wheel 1 drives the steering column 5 to rotate to the same side, and the spiral groove on the steering column 5 drives one end of the limiting block to move upward or downward along the axial direction of the steering column 5, while the other end of the limiting block moves in the same direction in the sliding groove 731. When the limiting block moves to abut the stopping portion 721 of the upper end of the spiral groove or the stopping portion 722 of the lower end thereof, the steering column 5 is prevented from continuing to rotate, thereby functioning as a limit. The moving direction of the limiting block is determined according to the rotation direction of the spiral groove. For example, in the present embodiment, the left turn (i.e., counterclockwise rotation) of the steering wheel 1 drives the steering column 5 to rotate to the left, and the spiral groove drives the limit block to moved upwards.

In the present embodiment, the limiting block is of a transverse “convex” shape. The end sliding in the spiral groove is trapezoidal, and the other end sliding in the sliding groove 731 is rectangular, and the limiting block moves in the axial direction of the steering column 5. The height of the trapezoid is smaller than the height of the rectangle, and a step is formed at the junction of the two, so that the left and right positions of the limiting block can be restricted to avoid jamming; it can be understood that other shapes are also possible, such as a wedge shape or a truncated cone shape, and it is also possible to be a rectangular shape or a cylindrical shape, and provide a positioning pin or the like in the middle.

The shape and position of the limiting structure of the steering wheel rotation limiting device 7 are not limited in the embodiment of the present disclosure. For example, in the present embodiment, the two stopping portions 721 and 722 are respectively disposed at upper and lower ends of the spiral groove, but in other embodiments, the two stopping portions 721, 722 may be respectively disposed at upper and lower ends of the sliding groove 731. In the present embodiment, the spiral groove is disposed on the steering column 5, and the sliding groove 731 is disposed in the limiting sleeve 73, but in other embodiments, the spiral groove may be disposed in the limiting sleeve 73, and the sliding groove 731 is disposed on the steering column 5.

The object of providing the rotation limiting device in the embodiment of the present disclosure is to avoid the problem that there is no limitation on the rotation angle of the steering wheel due to the elimination of the mechanical structure. If the rotation angle of the steering wheel is too large, so that the rotation angle of the wheel is too large, for example, if the rotation angle of the wheel exceeds 90 degrees, the vehicle will turn in the opposite direction, causing confusion.

In addition, the steering wheel rotation limiting device 7 is disposed along the circumferential direction of the steering column 5. Compared with the gear and pinion limit manner in the prior design, the steering wheel rotation limiting device of the embodiment of the present disclosure occupies smaller space, thereby further reducing the space occupied by the steering wheel assembly.

### Embodiment 2

As shown in FIG. 3, a vehicle is further provided in an embodiment of the present disclosure. The vehicle includes a vehicle body 6 and the vehicle steering wheel assembly according to Embodiment 1. The steering column 5 is rotatably mounted to the vehicle body 6, and the road sense simulator 3 is fixed to the vehicle body 6. The control component 4 is an electronic control unit (ECU). ECU is also called “driving computer”, “on-board computer”, etc., which is a vehicle-specific microcomputer controller for use. Like ordinary computers, the ECU is composed of a microprocessor (CPU), a memory (ROM and RAM), an input/output interface (I/O), an analog-to-digital converter (A/D), and a large scale integrated circuit such as waveshaping, driver, etc. In this way, it is not necessary to separately provide control components on the vehicle steering wheel assembly, so that the structure is simplified and the cost is saved. It can be understood that the control component 4 can also be an independent control component separately provided on the vehicle steering wheel assembly, rather than an ECU.

The vehicle of the embodiment of the present disclosure is mainly a four-wheeled vehicle, typically such as a car.

The vehicle of the embodiment of the disclosure eliminates the mechanically connected steering system, and instead uses the steer-by-wire steering system and the vehicle steering wheel assembly according to Embodiment 1, so that the vehicle is lighter and the structure is simpler, thereby enabling the steering of the vehicle to be faster and more flexible to meet the requirements of vehicle intelligence.

1. A vehicle steering wheel assembly, wherein the vehicle steering wheel assembly comprises a steering wheel, a control component, a rotation measuring component for measuring a rotation condition of the steering wheel, and a road sense simulator for applying a resistance torque to a rotation of the steering wheel according to the rotation condition of the steering wheel; a steering column is disposed under the steering wheel, wherein an upper end of the steering column is connected to the steering wheel, and a lower end of the steering column is connected to the road sense simulator, and the road sense simulator is fixed to a vehicle body of the vehicle;
the rotation measuring component and the road sense simulator are both connected to the control component, and the control component controls the road sense simulator to apply the resistance torque to the rotation of the steering wheel according to measurement data of the rotation measuring component.

2. The vehicle steering wheel assembly according to claim 1, wherein the road sense simulator comprises a motor, wherein the lower end of the steering column is connected to an output shaft of the motor, and the steering column and the output shaft rotate coaxially; and a housing of the motor is fixed to the vehicle body of the vehicle, and an output torque of the motor is the resistance torque applied to the rotation of the steering wheel by the road sense simulator.

3. The vehicle steering wheel assembly according to claim 2, wherein the rotation measuring member is an encoder, and the encoder includes a fixing portion and a measuring portion, wherein the fixing portion is fixed to an upper end of the housing of the motor, and the measuring portion is sleeved on the output shaft.

4. The vehicle steering wheel assembly according to claim 2, wherein the road sense simulator further comprises a motor controller, wherein the motor controller is fixed to the housing of the motor, and the motor controller receives a control signal of the control component and controls the output torque of the motor according to the control signal.

5. The vehicle steering wheel assembly according claim 1, wherein the vehicle steering wheel assembly further comprises a steering wheel rotation limiting device, wherein the steering wheel rotation limiting device comprises a first limiting member and a second limiting member; the first limiting member is slidably mounted on the steering column, and the first limiting member is movable along an axial direction of the steering column with the rotation of the steering wheel; the second limiting member is disposed on the steering column, and an upper end and a lower end of the second limiting member are respectively provided with a stopping portion, and the stopping portions are respectively positioned above and below the first limiting member, wherein, after the steering wheel is rotated by a predetermined angle, the first limiting member abuts against the stopping portion of the upper end or the lower end of the second limiting member, and the rotation of the steering wheel is restricted.

6. The vehicle steering wheel assembly according to claim 5, wherein the first limiting member is a limiting block movable along the axial direction of the steering column, and the second limiting member is a spiral groove with a preset number of circles which is provided on an outer cylindrical surface of the steering column and sets an axis of the steering column as its axis, wherein one end of the limiting block is slidable in the spiral groove, and the start portion and the end portion of the spiral groove are two stopping portions of the second limiting member; and the steering wheel rotation limiting device further comprises a limiting sleeve, wherein the limiting sleeve is fixed on the vehicle body of the vehicle and is sleeved on the steering column, and an inner wall of the limiting sleeve is provided with a sliding groove for accommodating an axial movement of other end of the limiting block.

7. A vehicle is characterized in that the vehicle comprises a vehicle body and the vehicle steering wheel assembly of claim 1; the steering column is rotatably mounted to the vehicle body, and the road sense simulator is fixed to the vehicle body; and the control component is an electronic control unit.

8. The vehicle according to claim 7, wherein the road sense simulator comprises a motor, wherein the lower end of the steering column is connected to an output shaft of the motor, and the steering column and the output shaft rotate coaxially; and a housing of the motor is fixed to the vehicle body, and an output torque of the motor is the resistance torque applied to the rotation of the steering wheel by the road sense simulator.

9. The vehicle according to claim 8, wherein the rotation measuring member is an encoder, wherein the encoder includes a fixing portion and a measuring portion, the fixing portion is fixed to an upper end of the housing of the motor, and the measuring portion is sleeved on the output shaft.

10. The vehicle of claim 7, wherein the steering wheel assembly further comprises a steering wheel rotation limiting device, wherein the steering wheel rotation limiting device comprises a first limiting member and a second limiting member; the first limiting member is slidably mounted on the steering column, and the first limiting member is movable along an axial direction of the steering column with the rotation of the steering wheel; the second limiting member is disposed on the steering column, and an upper end and a lower end of the second limiting member are respectively provided with a stopping portion, and the stopping portions are respectively positioned above and below the first limiting member, wherein, after the steering wheel is rotated by a predetermined angle, the first limiting member abuts against the stopping portion of the upper end or the lower end of the second limiting member, and the rotation of the steering wheel is restricted.
